(19) United States
(12) Patent Application Publication
(10) Pub. No.: US 2013/0146517 A1
(43) Pub. Date: Jun. 13, 2013

(54) FILTERING ASSEMBLY HAVING SEDIMENT TRAP

(71) Applicant: Craig D. O'Brien, Oxford, MI (US)

(72) Inventor: Craig D. O'Brien, Oxford, MI (US)

(73) Assignee: GM GLOBAL TECHNOLOGY OPERATIONS LLC, DETROIT, MI (US)

(21) Appl. No.: 13/324,657

(22) Filed: Dec. 13, 2011

(51) Int. Cl. B01D 35/02; B01D 21/00

(52) U.S. Cl. 210/153; 210/767

(57) ABSTRACT

A filtering assembly for collecting sediment from fluid of a powertrain device is provided. The filtering assembly includes a bottom pan and a sediment trap. The bottom pan has a bottom surface and is configured to collect the fluid of the powertrain device. The bottom pan may have a side wall cooperating with its bottom surface to define a cavity within the bottom pan. The sediment trap has opposed upper and lower surfaces. The lower surface may be attached to the bottom pan. The upper surface is configured to receive the sediment when the sediment falls toward the bottom surface of the bottom pan as the sediment is acted on by gravity. The sediment trap is configured to trap sediment received through its upper surface. A method for collecting sediment from the fluid of a powertrain device is also provided.

### FIELD

The present invention relates to fluid filter assemblies, and more specifically to a filtering assembly for use in filtering sediment from fluid of a powertrain device.

### BACKGROUND

The statements in this section merely provide background information related to the present invention and may or may not constitute prior art.

A typical automatic transmission includes an electronically controlled hydraulic control circuit or system that uses a hydraulic fluid to actuate torque transmitting mechanisms, as well as to lubricate and cool the transmission. The hydraulic fluid is typically stored in a fluid reservoir, or sump, disposed at a bottom of the transmission. A pump connected to the sump is used to draw the hydraulic fluid from the sump and communicate the hydraulic fluid throughout the hydraulic control system. Engines also use fluids for lubrication and cooling, which may be filtered through a canister filter or other means.

In order to prevent damage to the control system or other components due to unwanted contaminants that may be present in the powertrain fluid, a filter is generally connected to the pump. The filter includes a filter element surrounded by a filter body having an inlet for incoming fluid and an outlet for outgoing fluid. The filter removes some of the contaminants from the fluid prior to entering the pump. In other words, the pump draws in fluid through the filter.

However, in order to remove finer sediment from oil based fluids, it is desirable to create very fine holes in filter media and increase the surface area of the filter, which results in increased loading of geroter pumps. Further, the surface area of the filter media typically has size constraints. Accordingly, there is a need for improvement to filtering devices.

### SUMMARY

In an example of the present invention, a filtering assembly is provided for collecting sediment from fluid of a powertrain device as the sediment falls within powertrain device. The filtering assembly includes a bottom pan and a sediment trap. The bottom pan has a bottom surface and is configured to collect the fluid of the powertrain device. The sediment trap has opposed upper and lower surfaces. The lower surface is attached to the bottom pan. The upper surface is configured to receive the sediment when the sediment falls toward the bottom surface of the bottom pan. The sediment trap is configured to trap the sediment after receiving the sediment through the upper surface.

In another form, which may be used in with or distinct from the previous or next form described, a filtering assembly is provided for collecting sediment from fluid of a powertrain device as the sediment falls within the powertrain device. The assembly includes a bottom pan and a sediment trap. The bottom pan has a bottom surface and a side wall. The side wall defines a cavity within the bottom pan. The bottom pan is configured to collect the fluid of the powertrain device within the cavity. The sediment trap is disposed within the cavity of the bottom pan. The sediment trap has opposed upper and lower surfaces. The lower surface is adjacent to the bottom surface of the bottom pan, and the upper surface is open to the cavity. The upper surface is configured to receive the sediment in the cavity when the sediment falls toward the bottom surface of the bottom pan and into the sediment trap as the sediment is acted on by gravity. The sediment trap is configured to trap the sediment received within the upper surface.

In another form, which may be used conjunctively or separately from the previous two forms described, the present invention provides a method for collecting sediment from fluid of a powertrain device. The method includes a step of receiving sediment particles through an upper surface of a sediment trap disposed in a cavity formed by a bottom pan of the powertrain device, wherein the upper surface of the sediment trap is configured to receive the sediment particles as they fall in a downward direction due to being acted on by gravity. The method further includes a step of trapping the sediment particles within the sediment trap.

Further examples, aspects and advantages of the present invention will become apparent by reference to the following description and appended drawings wherein like reference numbers refer to the same component, element or feature.

### BRIEF DESCRIPTION OF THE DRAWINGS

The drawings described herein are for illustration purposes only and are not intended to limit the scope of the present disclosure in any way.

FIG. 1 is an exploded perspective view of a portion of a transmission having a filtering assembly in accordance with an embodiment of the present invention;

FIG. 2 is a cross-sectional view of the filtering assembly of FIG. 1 in accordance with an embodiment of the present invention; and

FIG. 3 is an exploded perspective view of another filtering assembly in accordance with the principles of the present invention.

### DETAILED DESCRIPTION

The present disclosure provides an improved filtering device for powertrain oil based fluids that removes sediment via gravity filtration. The filtering assembly of the present disclosure may be used with any powertrain device, such as an engine or transmission. The filtering assembly, which uses gravity settling, may remove even the smallest of sediments from powertrain fluids. Sediment removal via gravity filtration may lead to increased life of powertrain components and/or could eliminate or lessen the need for canister filtration systems. New engine oil or transmission filters could be needed less regularly.

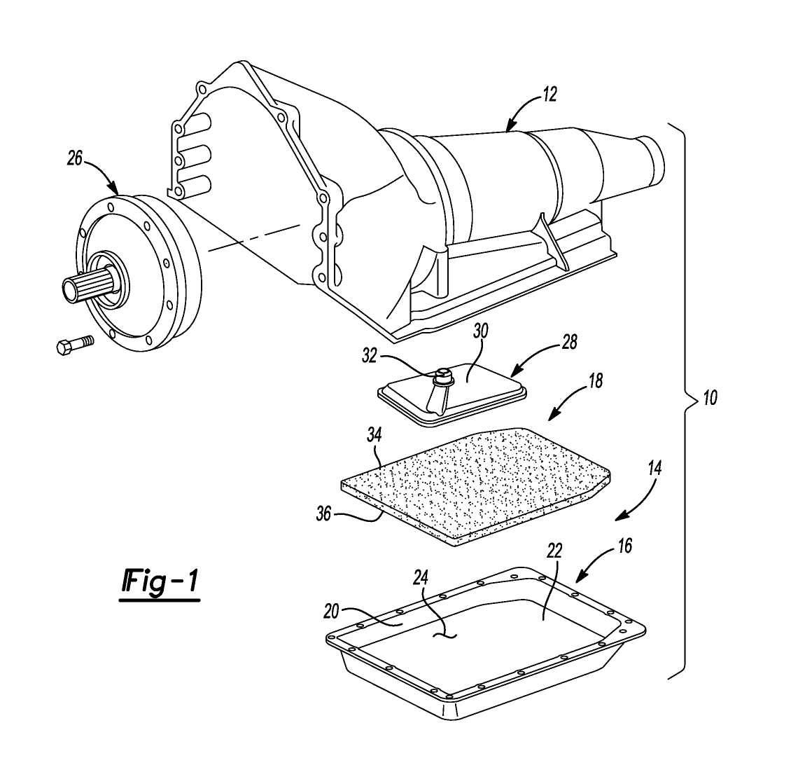

With reference to FIG. 1, a portion of an exploded transmission is illustrated and generally indicated by reference number 10. The transmission 10 includes a transmission case 12. A filtering assembly 14 is provided that includes a sump pan, or bottom pan 16, and a sediment trap 18. The bottom pan 16 has a wall or walls 20 that cooperate with a bottom surface 22 of the bottom pan 16 to form a cavity 24 within the bottom pan 16 that is used as a fluid reservoir for storing hydraulic fluid. The cavity 24 has an open end on the upper side of the bottom pan 16. The outer walls 20 are configured to be attached to the transmission case 12 to enclose the open end of the cavity 24.

The fluid in the bottom pan 16 is in fluid communication with the pump 26. The pump 26 is operable to draw or suck the hydraulic fluid from the bottom pan 16 and communicate the hydraulic fluid under pressure throughout the transmission 10, as required. The pump 26 is driven by a prime mover, such as a combustion engine, electric engine, or hybrid plant. It should be appreciated that the pump 26 may be any positive displacement pump without departing from the scope of the present invention.

A transmission filter 28 is disposed between the bottom pan 16 and the pump 26. The pump 26 is operable to draw fluid from the reservoir in the cavity 24 of the bottom pan 16, through the transmission filter 28, and into the pump 26. The transmission filter 28 filters the hydraulic fluid as the hydraulic fluid leaves the bottom pan 16 prior to entering the pump 26. The transmission filter includes a substantially rigid housing 30 that may be formed from injection molded plastic. The housing 30 surrounds a filter media (not shown) encased inside the housing 30. The housing 30 has a filter outlet 32 that may be press fit into a fluid inlet (not shown) of the pump 26 to feed fluid to the pump 26. An inlet (not shown) on the transmission filter 28, which may be disposed on its underside, may draw fluid from the fluid reservoir in the bottom pan 16 into the transmission filter 26.

The filtering assembly 14, including the sediment trap 18 and the bottom pan 16, is configured to collect or separate sediment from the fluid of the transmission 10 or other powertrain device. The sediment trap 18 has opposed upper and lower surfaces 34, 36. The lower surface 36 may be attached to the bottom pan 16. In FIG. 1, the sediment trap 18 has roughly the same hexagonal shape as the bottom surface 22 of the bottom pan 16, so that the sediment trap 18 fits into the bottom pan 16 and substantially covers the bottom surface 22 of the bottom pan 16 when the filtering assembly 14 is assembled. In this embodiment, the lower surface 36 of the sediment trap 18 sits directly on and in contact with the bottom surface 22 of the bottom pan 16.

When the filtering assembly 14 is assembled and in use, the upper surface 34 of the sediment trap is configured to receive sediment from the transmission fluid by virtue of the sediment falling onto and into the sediment trap 18 that is disposed on the bottom surface 22 of the bottom pan 16. The sediment trap 18 may alternatively be disposed above the bottom surface 22 of the bottom pan, without falling beyond the spirit and scope of the present disclosure. Because the sediment is heavier than the fluid in which it resides, the sediment falls toward the bottom surface 22 of the bottom pan 16. The sediment trap 18 is configured to trap the sediment that comes into contact with it. The sediment trap 18 receives the sediment through its porous upper surface 34 and traps the sediment within itself or under itself within the bottom pan 16.

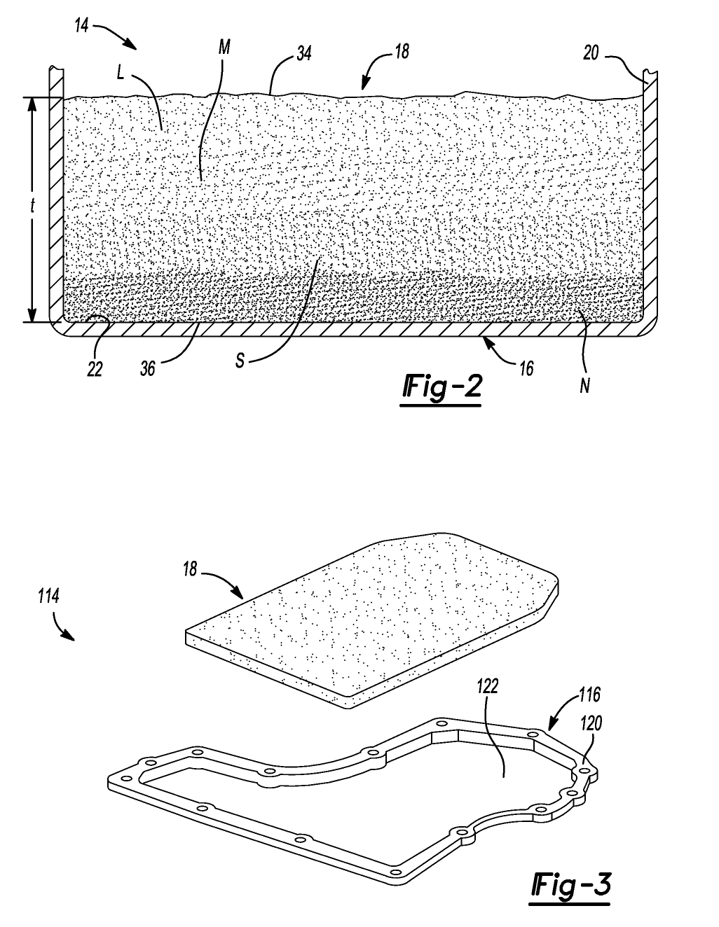

With reference to FIG. 2, a cross-sectional view of an assembled filtering assembly 14 is illustrated. It should be understood that this is only one variation of the sediment trap 18 in accordance with the present invention. In FIG. 2, the lower surface 36 of the sediment trap 18 is direction on and in contact with the bottom surface 22 of the bottom pan.

The sediment trap 18 has varying density and/or varying sizes of pores throughout its thickness t. For example, in FIG. 2, the sediment trap has relatively large pores L near its upper surface 34. The large pores L could be, for example, about 100 microns in diameter. Below the large pores L, the sediment trap 18 could have slightly smaller upper medium-sized pores M with that are, for example, about 50 microns in diameter. Below the medium-sized pores M, the sediment trap 18 could have small pores S that are smaller than the large and medium-sized pores L, M, and that have, for example, about 25 micron diameters. Finally, below the large, medium-sized, and small pores L, M, S, the sediment trap 18 could have tiny pores N that are, for example, about 10 microns in diameter. The pores could gradually get smaller going from the upper surface 34 of the sediment trap 18 to the lower surface 36 of the sediment trap 18. The sediment trap 18 may define a series of sieves throughout its thickness t, where the upper pores or sieves are larger than the lower pores or sieves.

It should be understood that FIG. 2 illustrates merely an example of configuration of the sediment trap 18, and other configurations are possible without falling beyond the spirit and scope of the present disclosure. For example, the sediment trap could have a constant density and/or constant size of pores throughout its thickness t. The total thickness t could be, for example, about two millimeters, or between about two and ten millimeters, or between about five and ten millimeters. Other thicknesses t not in that range may also be employed, depending on the particular application and the particular bottom pan 16 to be used.

A surrounding structure defines the holes L, M, S, N. The surrounding structure is configured to trap sediment that falls into any of the holes. In other words, gravity causes the sediment to fall through at least some of the holes L, M, S, N, and the sediment gets trapped by the structure of the sediment trap 18 that surrounds and defines the holes. Finer sediment falls to the bottom, as the upper holes are larger than the lower holes in some embodiments.

The sediment trap 18 may be formed of one or more porous, absorbent pads, or one or more pieces of felt or felt pads. The sediment trap 18 could be formed of any suitable material, such as a polyester material; however, it should be understand that other materials may also be acceptable, without falling beyond the spirit and scope of the present disclosure.

When assembled, the transmission filter 28 is disposed adjacent to the upper surface 34 of the sediment trap 18. Because of its substantially rigid and nonabsorbent housing 30, the transmission filter 28 does not collect sediment when sediment falls toward the bottom surface 22 of the bottom pan 16 due to its own weight. Rather, the transmission filter 28 filters some of the sediment from the hydraulic fluid when it is drawn through the transmission filter 28 by the pump 26.

As described above, the upper surface 34 of the sediment trap 18 is porous, and the upper surface 34 is open to the cavity 24 in the bottom pan 16. Accordingly, the sediment in the fluid lands on or falls into the upper surface 34 of the sediment trap 18 when the sediment falls in a downward direction toward the bottom surface 22 of the bottom pan 16 by virtue of gravity. The sediment trap collects sediment from the fluid by trapping the sediment within its porous structure. The sediment trap 18 may be attachment to the bottom surface 22 of the bottom pan 16 by glue, mechanical objects, or by any other means, or in the alternative, the sediment trap 18 need not be attached to the bottom surface 22 of the bottom pan 16. In such a case, the sediment trap 18 may reside in the cavity 24 of the bottom pan 16 without being attached to the bottom pan 16.

With reference to FIG. 3, another variation of a filtering assembly 114 is illustrated within the spirit and scope of the present disclosure. The filtering assembly 114 has a bottom pan 116 having a bottom surface 122 surrounding by a lip 120. In this example, the same sediment trap 18 hereinbefore described is illustrated exploded from the bottom pan 116, but it should be understood that the sediment trap 18 will reside within the bottom pan 116 when assembled. The sediment trap 18 has a hexagonal shape that differs from the shape of the bottom surface 122 of the bottom pan 116. Thus, the sediment trap 18 will cover less than the entire bottom surface 122 of the bottom pan 116, in this embodiment. Other different shapes of bottom pans and sediment traps may alternatively be used, without falling beyond the spirit and scope of the present disclosure. For example, the sediment trap 18 could be attached or placed above the bottom surface 22, 122 of the bottom pan 16, 116 instead of directly on the bottom surface 22, 122 of the bottom pan 16, 116 without falling beyond the spirit and scope of the present invention.

A method for collecting sediment from fluid of a powertrain device, such as a transmission 10 or engine, is contemplated. The method includes a step of receiving sediment particles through the upper surface 34 of the sediment trap 18. The sediment trap 18 may be disposed in the cavity 24 formed by the wall or walls 20 and the bottom surface 22 of the bottom pan 16. The upper surface 34 is configured to receive the sediment particles as they fall in a downward direction due to being acted on by gravity. As the sediment particles are received into the upper surface 34 through holes or sieves, the surrounding structures to the holes/sieves trap the sediment particles within the sediment trap 18. The sediment particles may be received into the upper surface 34 of the sediment trap 18 when the powertrain device 10 is at rest. Thus, the sediment particles will fall toward the bottom surface 22 of the bottom pan 16 and settle out of the powertrain fluid.

The description of the invention is merely exemplary in nature and variations that do not depart from the gist of the invention are intended to be within the scope of the invention. Such variations are not to be regarded as a departure from the spirit and scope of the invention. For example, in some embodiments, the transmission filter 28 may be omitted and the filtering assembly 14 including the bottom pan 16 and the sediment trap 18 may be the only and sole filtering device employed. In other variations, the filtering assembly 14, including the sediment trap 18 and the bottom pan 16, may be used in parallel with another filtering system, such as an engine oil filter. Although an engine and an engine oil pan, or bottom pan, are not shown in the figures, it should be understood that the present filtering assembly 14, 114, including the bottom pan 16, 116 and sediment trap 18, may be used in connection with an internal combustion engine or other engine or motor, instead of with a transmission 10.

What is claimed is:

1. A filtering assembly for collecting sediment from fluid of a powertrain device as the sediment falls within powertrain device, the filtering assembly comprising:
a bottom pan having a bottom surface, the bottom pan configured to collect the fluid of the powertrain device; and
a sediment trap having opposed upper and lower surfaces, the lower surface attached to the bottom pan, the upper surface configured to receive the sediment when the sediment falls toward the bottom surface of the bottom pan, the sediment trap configured to trap the sediment after receiving the sediment through the upper surface.

2. The filtering assembly of claim 1 wherein the sediment trap defines a plurality of sieves and surrounding structures, the plurality of sieves configured to allow sediment to fall through the sieves, the surrounding structures configured to trap the sediment.

3. The filtering assembly of claim 2, wherein the sediment trap has a thickness, the plurality of sieves comprising upper sieves and lower sieves within the thickness of the sediment trap, the upper sieves being larger than the lower sieves.

4. The filtering assembly of claim 1, the sediment trap being formed of a porous absorbent pad.

5. The filtering assembly of claim 4, the sediment trap being formed of a polyester material.

6. The filtering assembly of claim 1, the sediment trap being formed of a felt pad.

7. The filtering assembly of claim 1 further comprising a transmission filter, the transmission filter disposed adjacent to the upper surface of the sediment trap.

8. The filtering assembly of claim 1 wherein the bottom pan has an outer wall that cooperates with the bottom surface to define a cavity in the bottom pan having an open end, the outer wall configured to be attached to a transmission case to enclose the open end.

9. The filtering assembly of claim 8 wherein the upper surface of the sediment trap is porous and open to the cavity in the bottom pan to collect the sediment from the fluid when the sediment falls in a downward direction as the sediment is acted on by gravity.

10. The filtering assembly of claim 1, the lower surface being attached to the bottom pan with glue.

11. The filtering assembly of claim, the sediment trap having a thickness of about two to ten millimeters.

12. A filtering assembly for collecting sediment from fluid of a powertrain device as the sediment falls within the powertrain device, the filtering assembly comprising:
a bottom pan having a bottom surface and a side wall, the side wall cooperating with the bottom surface to define a cavity within the bottom pan, the bottom pan configured to collect the fluid of the powertrain device within the cavity; and
a sediment trap disposed within the cavity of the bottom pan, the sediment trap having opposed upper and lower surfaces, the lower surface being disposed adjacent to the bottom surface of the bottom pan, the upper surface being open to the cavity and configured to receive the sediment when the sediment falls toward the bottom surface of the bottom pan and into the sediment trap as the sediment is acted on by gravity, the sediment trap being configured to trap the sediment received within the upper surface.

13. The filtering assembly of claim 12 wherein the sediment trap is attached directly to the bottom pan.

14. The filtering assembly of claim 12 wherein the sediment trap defines a plurality of sieves and surrounding structures, the plurality of sieves configured to allow sediment to fall through the sieves, the surrounding structures configured to trap the sediment.

15. The filtering assembly of claim 14, wherein the sediment trap has a thickness, the plurality of sieves comprising upper sieves and lower sieves within the thickness of the sediment trap, the upper sieves being larger than the lower sieves.

16. The filtering assembly of claim 12, the powertrain device being an engine.

17. The filtering assembly of claim 12, the powertrain device being a transmission.

18. The filtering assembly of claim 12 further comprising a transmission filter, the transmission filter disposed adjacent to the upper surface of the sediment trap.

19. A method for collecting sediment from fluid of a powertrain device, the method comprising:
receiving sediment particles through an upper surface of a sediment trap disposed in a cavity formed by a bottom pan of the powertrain device, wherein the upper surface of the sediment trap is configured to receive the sediment particles as they fall in a downward direction due to being acted on by gravity; and
trapping the sediment particles within the sediment trap.

20. The method of claim 19 wherein the step of receiving the sediment particles is undertaken while the powertrain device is at rest.
